(19) United States
(12) Patent Application Publication
(10) Pub. No.: US 2026/0106205 A1
(43) Pub. Date: Apr. 16, 2026

(54) BATTERY AND METHOD FOR MANUFACTURING THE SAME

(71) Applicant: TOYOTA JIDOSHA KABUSHIKI KAISHA, Toyota-shi (JP)

(72) Inventor: Hiroyuki NAKAYAMA, Okazaki-shi (JP)

(73) Assignee: TOYOTA JIDOSHA KABUSHIKI KAISHA, Toyota-shi (JP)

(21) Appl. No.: 19/218,983

(22) Filed: May 27, 2025

(30) Foreign Application Priority Data
Oct. 16, 2024 (JP) 2024-180754

(51) Int. Cl. H01M 10/04

(52) U.S. Cl. CPC H01M 10/0486; H01M 10/0418

(57) ABSTRACT

A battery includes: a plurality of electrode sheets stacked in a specific direction and connected in series; and an outer frame made of resin and covering peripheries of the electrode sheets. The outer frame has a first hole extending from a surface of the outer frame in the specific direction through at least one of the electrode sheets to a specific electrode sheet out of the electrode sheets. A side surface of the first hole is covered with resin. The side surface of the first hole is a side surface extending in the specific direction.

### CROSS-REFERENCE TO RELATED APPLICATION

This application claims priority to Japanese Patent Application No. 2024-180754 filed on Oct. 16, 2024. The disclosure of the above-identified application, including the specification, drawings, and claims, is incorporated by reference herein in its entirety.

### BACKGROUND

### 1. Technical Field

The present specification relates to a battery in which a plurality of electrode sheets is stacked, and a method for manufacturing the battery.

### 2. Description of Related Art

Japanese Unexamined Patent Application Publication No. 2021-082410 (JP 2021-082410 A) discloses a battery including a plurality of electrode sheets stacked in a specific direction and connected in series, and an outer frame made of resin and covering the peripheries of the electrode sheets.

### SUMMARY

One possible method to deactivate all of multiple electrode sheets is to discharge them all at once by short-circuiting between one end and the other end of the electrode sheets connected in series. However, with this method, variations in discharge may occur among the electrode sheets, and some of the electrode sheets may not be able to be sufficiently discharged.

The present specification provides a technique for reducing variations in discharge among a plurality of electrode sheets.

A battery disclosed in the present specification includes:
a plurality of electrode sheets stacked in a specific direction and connected in series; and
an outer frame made of resin and covering peripheries of the electrode sheets.

The outer frame has a first hole. The first hole extends from a surface of the outer frame in the specific direction through at least one of the electrode sheets to a specific electrode sheet out of the electrode sheets.

A side surface of the first hole is covered with resin. The side surface is a side surface extending in the specific direction.

With the above configuration, it is possible to short-circuit between one end of the plurality of electrode sheets and the specific electrode sheet by using the first hole. As a result, the electric charge between the one end and the specific electrode sheet can be discharged. It is also possible to short-circuit between the other end of the plurality of electrode sheets and the specific electrode sheet by using the first hole. As a result, the remaining electric charge between the other end and the specific electrode sheet can be discharged. By using the first hole, it is possible to separately discharge the electric charge within the plurality of electrode sheets. This can reduce variations in discharge among the electrode sheets, compared to the method in which a plurality of electrode sheets is discharged all at once.

The present specification further discloses a method of manufacturing a battery. The method includes:
preparing one or more first electrode sheets, with a resin layer formed in a frame shape on a periphery of the first electrode sheet, and a through hole formed in the periphery of the first electrode sheet so as to extend through the resin layer and the first electrode sheet;
preparing a second electrode sheet, with a resin layer formed in a frame shape on a periphery of the second electrode sheet, and an exposed hole formed on the periphery of the second electrode sheet so as to extend through the resin layer and expose the second electrode sheet;
stacking, in a specific direction, a plurality of electrode sheets including the one or more first electrode sheets and the second electrode sheet such that the through hole of the one or more first electrode sheets and the exposed hole of the second electrode sheet are aligned in the specific direction to form a series of holes;
forming, by welding the resin layer of the one or more first electrode sheets and the resin layer of the second electrode sheet, an outer frame that covers peripheries of the electrode sheets, the outer frame being formed such that a first hole extends from a surface of the outer frame in the specific direction through the one or more first electrode sheets to the second electrode sheet; and
covering, with resin, a side surface of the first hole that extends in the specific direction.

Details and further improvements of the technique disclosed in the present specification will be set forth in the section “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view of a battery;

FIG. 2 is a plan view of an electrode sheet;

FIG. 3 is an enlarged view of the scope III and a cross-sectional view thereof;

FIG. 4 is a diagram illustrating a method of manufacturing a battery;

FIG. 5 is a partial cross-sectional view of the battery mounted on a vehicle according to a first embodiment; and

FIG. 6 is a partial cross-sectional view of the battery mounted on a vehicle according to the second embodiment.

### DETAILED DESCRIPTION OF EMBODIMENTS

### First Embodiment

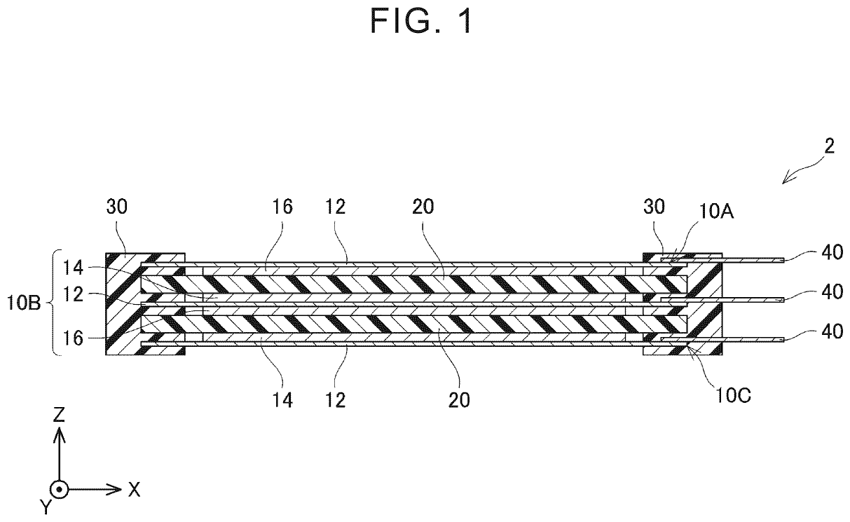

### Configuration of Battery 2; FIG. 1

The battery 2 includes a plurality of electrode sheets 10A to 10C, a plurality of separators 20, and an outer frame 30. In FIG. 1, an XYZ coordinate system is defined. As an example, the battery 2 is a lithium-ion battery.

The electrode sheets 10A to 10C are stacked in the Z-axis and are connected in series. The electrode sheet 10A is a unipolar positive electrode sheet. The electrode sheet 10B is a bipolar electrode sheet. The electrode sheet 10C is a unipolar negative electrode sheet. The electrode sheet 10A is formed by stacking the current collector 12 and the positive electrode active material 16. The current collector 12 of the electrode sheet 10A may be, for example, an aluminum foil. The electrode sheet 10B is formed by stacking the negative electrode active material 14, the current collector 12, and the positive electrode active material 16. The current collector 12 of the electrode sheet 10B may be, for example, a stack of an aluminum foil and a copper foil. The electrode sheet 10C is formed by stacking the negative electrode active material 14 and the current collector 12. The current collector 12 of the electrode sheet 10C may be, for example, a copper foil. In addition, in each of the electrode sheets 10A, 10B, 10C, various positive electrode active materials and negative electrode active materials for lithium-ion batteries can be appropriately employed as the positive electrode active material 16 and the negative electrode active material 14.

The separator 20 is sandwiched between the electrode sheet 10A and the electrode sheet 10B. The separator 20 is also sandwiched between the electrode sheet 10B and the electrode sheet 10C. As shown in FIG. 1, the electrode sheets 10A to 10C and the separators 20 are alternately stacked in the Z-axis direction. The outer frame 30 covers the peripheries of the electrode sheets 10A to 10C and is made of plastic.

A voltage detection terminal 40 for detecting a voltage of each of the electrode sheets 10A to 10C is connected to each of the electrode sheets 10A to 10C. The voltage detection terminal 40 extends from the periphery of each of the electrode sheets 10A to 10C through the outer frame 30 to the outside of the outer frame 30.

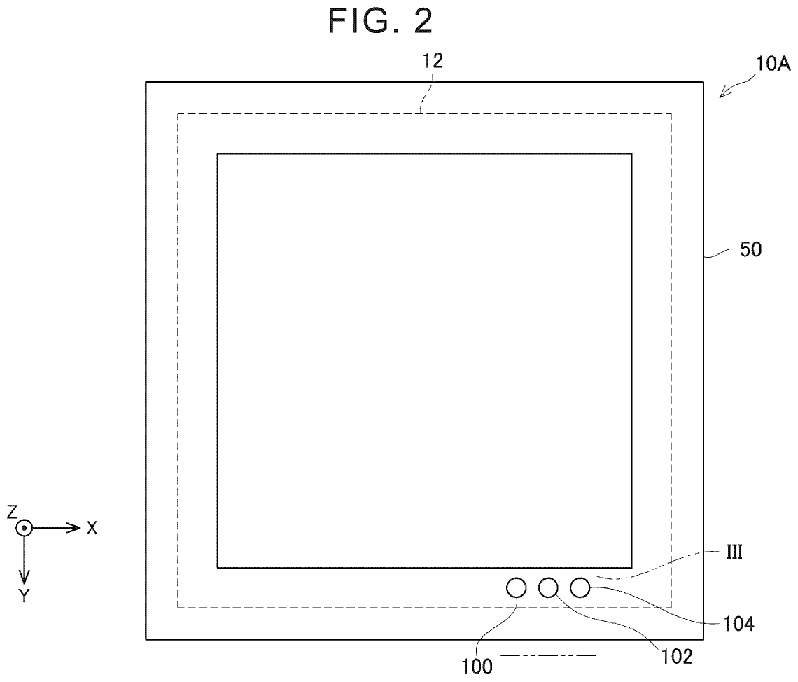

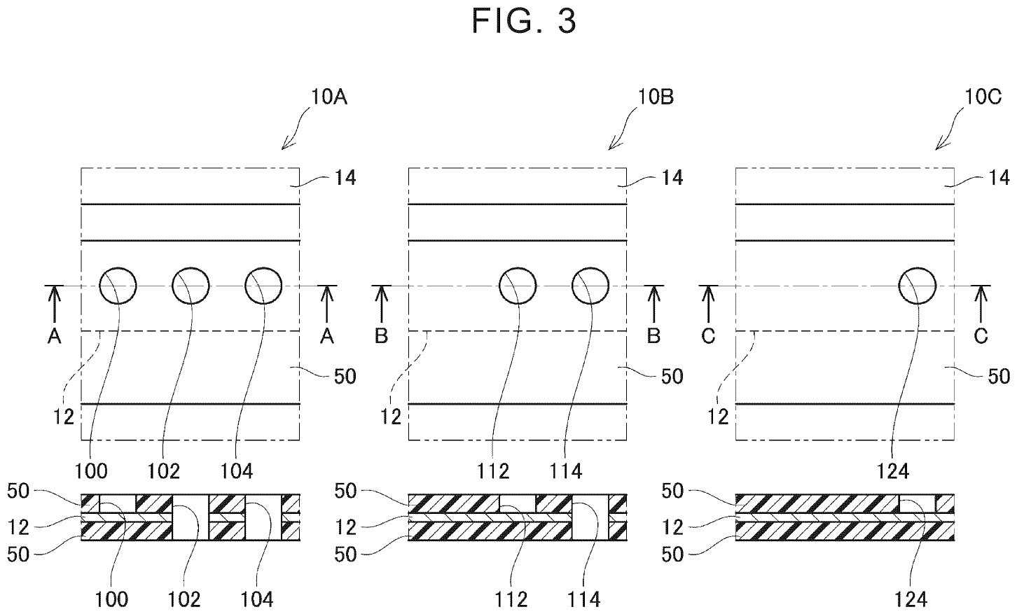

### Configuration of Electrode Sheet 10A; FIGS. 2, 3

FIG. 2 shows a plan view of the electrode sheet 10A before stacking. A resin layer 50 is formed in a frame shape on the periphery of the electrode sheet 10A before stacking. The resin layer 50 covers both front and back surfaces of the current collector 12 on the electrode sheet 10A. The resin layer 50 is an original member of the outer frame 30 of FIG. 1. An exposed hole 100, a through hole 102, and a through hole 104 are formed in part of the resin layer 50. As shown in FIG. 3, the exposed hole 100 passes through the resin layer 50 on the front side to expose the current collector 12 on the electrode sheet 10A. The through holes 102, 104 extend through the resin layer 50 on the front side, the current collector 12, and the resin layer 50 on the back side.

### Configuration of Electrode Sheet 10b; FIG. 3

A resin layer 50 that is the same as that for the electrode sheet 10A before stacking is also formed in a frame shape on the periphery of the electrode sheet 10B before stacking. In the resin layer 50 of the electrode sheet 10B, holes having a pattern that differs from the electrode sheet 10A are formed. Specifically, an exposed hole 112 that exposes the current collector 12 and a through hole 114 that extends through the current collector 12 and the resin layer 50 are formed in part of the resin layer 50 on the electrode sheet 10B.

### Configuration of Electrode Sheet 10c; FIG. 3

A resin layer 50 that is the same as that for the electrode sheets 10A, 10B before stacking is formed in a frame shape also on the periphery of the electrode sheet 10C before stacking. In the resin layer 50 of the electrode sheet 10C, holes having a pattern that differs from the electrode sheets 10A, 10B are formed. Specifically, an exposed hole 124 that exposes the current collector 12 is formed in part of the resin layer 50 on the electrode sheet 10C.

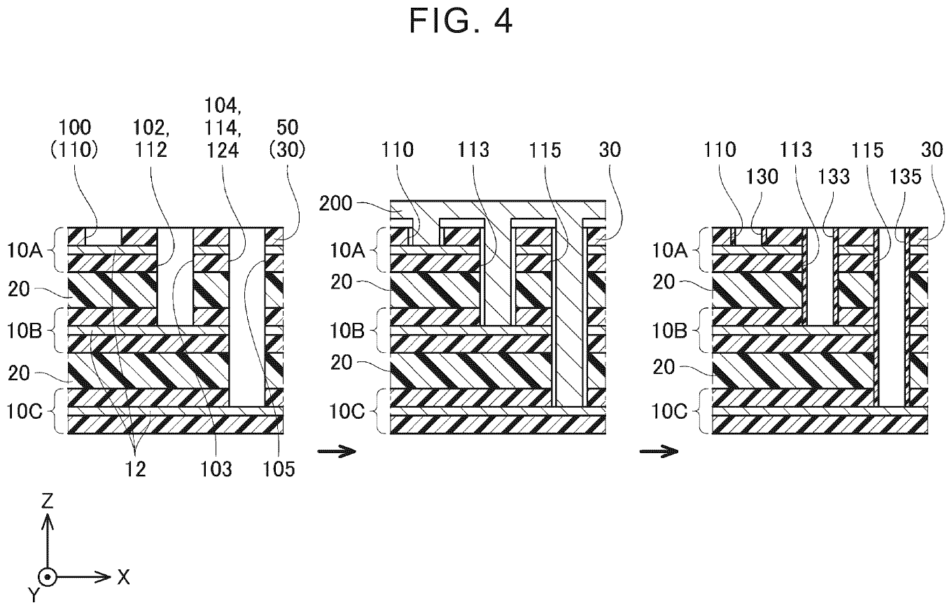

### Method for Manufacturing Battery 2; FIG. 4

A method for manufacturing the battery 2 will be described with reference to FIG. 4. In a first step, the electrode sheets 10A, 10B, 10C before stacking are prepared. In the second step, the electrode sheets 10A, 10B, 10C and the separators 20 are alternately stacked in the Z-axis direction. The separator 20 is also provided with a through hole (not shown) formed along the Z-axis direction. In this step, the through hole 104 of the electrode sheet 10A, the through hole 114 of the electrode sheet 10B, the through hole of the separator 20, and the exposed hole 124 of the electrode sheet 10C are aligned along the Z-axis direction, thereby forming a series of holes 105. In addition, the through hole 102 of the electrode sheet 10A, the through hole of the separator 20, and the exposed hole 112 of the electrode sheet 10B are aligned along the Z-axis to form a series of holes 103.

In the third step, the outer frame 30 is formed by welding the resin layers 50 of the electrode sheets 10A to 10C together. As a result, the series of holes 105 becomes a hole 115 that extends from the surface of the outer frame 30 in the Z-axis direction through the electrode sheets 10A, 10B to the current collector 12 on the electrode sheet 10C. Furthermore, the series of holes 103 becomes a hole 113 that extends from the surface of the outer frame 30 in the Z-axis direction through the electrode sheet 10A to the current collector 12 on the electrode sheet 10B. Further, the exposed hole 100 becomes a hole 110 that exposes the current collector 12 of the electrode sheet 10A on the surface of the outer frame 30 in the Z-axis direction.

Thereafter, in the fourth step, a mold 200 is inserted into the three holes 110 to 115. The mold 200 includes a rod-shaped portion 210 that is inserted into the hole 110, a rod-shaped portion 213 that is inserted into the hole 113, and a rod-shaped portion 215 that is inserted into the hole 115. A gap into which the resin flows is formed between each of the rod-shaped portions 210 to 215 and a side surface (hereinafter, referred to as an “inner wall”) extending along the Z-axis direction in each of the holes 110 to 115.

In the fifth step, the resin is poured into the gaps between the mold 200 and the three holes 110 to 115. As a result, the resin wall 130 is injection-molded on the inner wall of the hole 110. Similarly, resin walls 133 and 135 are injection-molded into the inner walls of the holes 113, 115, respectively. By covering the inner walls of the holes 110 to 115 with the resin walls 130 to 135, the gap between the current collector 12 and the outer frame 30 and the gap between the separator 20 and the outer frame 30 are sealed.

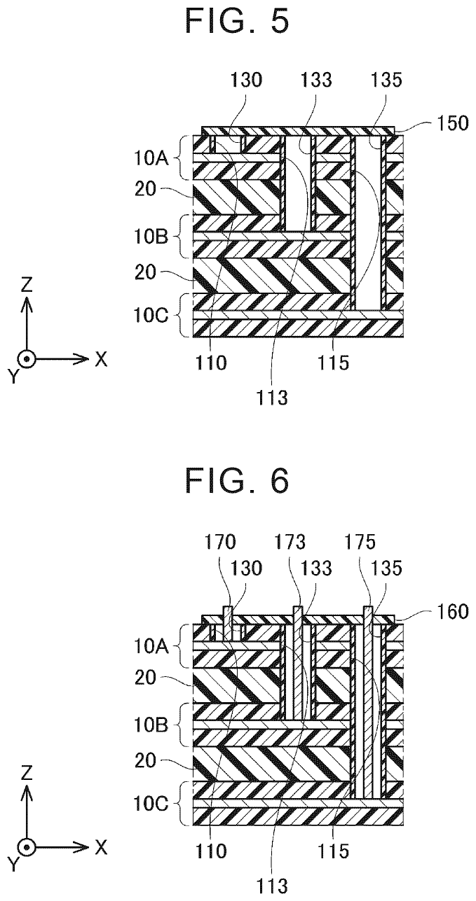

When the entire process is completed, the battery 2 is completed. The battery 2 is mounted on, for example, a vehicle such as a battery electric vehicle or a hybrid electric vehicle. When mounted on a vehicle, the three holes 110 to 115 are closed with a lid 150, as shown in FIG. 5.

For example, a situation in which the battery 2 is removed from the vehicle by maintenance, disassembly, or the like of the vehicle is assumed. For safety, it is desirable to deactivate all of the electrode sheets 10A to 10C of the battery 2. For example, it is conceivable to discharge the electrode sheets 10A to 10C all at once by short-circuiting between the electrode sheet 10A that is one end of the stacked electrode sheets 10A to 10C and the electrode sheet 10C that is the other end thereof. However, this method causes variations in discharge among the electrode sheets 10A to 10C, and part of the electrode sheets may not be able to be sufficiently discharged.

In the battery 2 of the present embodiment, three holes 110 to 115 are formed. In the present embodiment, three holes 110 to 115 can be used to separately discharge the electrode sheets 10A to 10C. For example, the worker removes the lid 150 from the battery 2. The worker inserts a lead wire reaching the current collector 12 into each of the holes 110 to 115. The worker short-circuits between the lead wire inserted into the hole 110 and the lead wire inserted into the hole 113. As a result, the electric charge accumulated in the electrode sheets 10A, 10B can be discharged. Further, the worker short-circuits between the lead wire inserted into the hole 113 and the lead wire inserted into the hole 115. As a result, the electric charge accumulated in the electrode sheets 10B, 10C can be discharged. It is possible to suppress variations in discharge among the electrode sheets 10A to 10C compared to the method in which the electrode sheets 10A to 10C are discharged all at once.

It is also conceivable to short-circuit between the voltage detection terminals 40 to separately discharge the electrode sheets 10A to 10C without using the three holes 110. However, the voltage detection terminal 40 is a terminal for voltage detection and is relatively thin. Therefore, a large current cannot flow, and a relatively long time is required until the discharge is completed. Further, when the voltage detection terminal 40 is made thicker, it is necessary to add a procedure of sealing between the voltage detection terminal 40 and the outer frame 30. According to the configuration of the present embodiment, it is possible to use a relatively thick lead wire according to the size of each of the holes 110 to 115. The time until the discharge is completed can be relatively short.

### Correspondence

The battery 2 and the Z-axis direction are an example of the “battery” and the “specific direction”, respectively. The electrode sheets 10A to 10C and the outer frame 30 are an example of the “plurality of electrode sheets” and “outer frame”, respectively. The electrode sheet 10B and the electrode sheet 10C are an example of the “specific electrode sheet” and “another electrode sheet”, respectively. The hole 113 and the hole 115 are an example of the “first hole” and the “second hole”, respectively. The resin layer 50 is an example of the “resin layer”. The electrode sheet 10A and the through hole 102 are an example of the “first electrode sheet” and the “through hole”, respectively. The electrode sheet 10B and the exposed hole 112 are an example of the “second electrode sheet” and the “exposed hole”, respectively. The series of holes 103 is an example of the “series of holes.”

### Second Embodiment

This embodiment is similar to the first embodiment except that the configuration of the lid 160 that closes the three holes 110 to 115 is different. The lid 160 is provided with three heat detection terminals 170, 173, 175. Thermocouples are provided at one end of the three heat detection terminals 170, 173, 175. The heat detection terminal 170 passes through the hole 110, and one end thereof contacts the current collector 12 of the electrode sheet 10A, and the other end thereof is exposed from the lid 160. The heat detection terminal 173 passes through the hole 113, and one end thereof contacts the current collector 12 of the electrode sheet 10B, and the other end thereof is exposed from the lid 160. The heat detection terminal 175 passes through the hole 115, and one end thereof contacts the current collector 12 of the electrode sheet 10C, and the other end thereof is exposed from the lid 160. A circuit for detecting an output value of a thermocouple in contact with the current collector 12 is connected to the other ends of the heat detection terminals 170, 173, 175. Three heat detection terminals 170, 173, 175 may be utilized to detect the temperature of 10C from the electrode sheet 10A. The temperature of each of the heat detection terminals 170, 173, 175 can be used, for example, to control the battery 2 mounted on the vehicle. A thermocouple provided at the other end of each of the heat detection terminals 170, 173, 175 is an example of a “thermocouple.”

In the following, points to be noted regarding the technology shown in the examples will be described. In each embodiment, the number of holes 110 etc. formed in the outer frame 30 is not limited to three, and may be two, or four or more. For example, only the hole 113 may be formed in the outer frame 30. In this case, the electric charge accumulated in the electrode sheets 10A, 10B can be discharged by short-circuiting between the lead wire inserted in the hole 113 and the electrode sheet 10A that is one end of the stacked electrode sheets 10A to 10C. The electric charge accumulated in the electrode sheets 10B, 10C can be discharged by short-circuiting between the lead wire inserted in the hole 113 and the electrode sheet 10C that is the other end of the stacked electrode sheets 10A to 10C. Forming at least one hole in the outer frame 30 allows each of the electrode sheets 10A to 10C to be separately discharged.

The number of electrode sheets to be stacked is not limited to three, and may be four or more. The battery 2 may comprise two or more bipolar electrode sheets.

What is claimed is:

1. A battery comprising:
a plurality of electrode sheets stacked in a specific direction and connected in series; and
an outer frame made of resin and covering peripheries of the electrode sheets, wherein:
the outer frame has a first hole, the first hole extending from a surface of the outer frame in the specific direction through at least one of the electrode sheets to a specific electrode sheet out of the electrode sheets; and
a side surface of the first hole is covered with resin, the side surface being a side surface extending in the specific direction.

2. The battery according to claim 1, wherein:
the outer frame has a plurality of holes including the first hole and a second hole; and
the second hole extends from the surface to another electrode sheet out of the electrode sheets, the another electrode sheet being different from the specific electrode sheet.

3. The battery according to claim 1, further comprising a thermocouple disposed in the first hole and in contact with the periphery of the specific electrode sheet.

4. The battery according to claim 1, wherein the electrode sheets include at least one bipolar electrode sheet.

5. A method for manufacturing a battery, the method comprising:
preparing one or more first electrode sheets, with a resin layer formed in a frame shape on a periphery of the first electrode sheet, and a through hole formed in the periphery of the first electrode sheet so as to extend through the resin layer and the first electrode sheet;
preparing a second electrode sheet, with a resin layer formed in a frame shape on a periphery of the second electrode sheet, and an exposed hole formed on the periphery of the second electrode sheet so as to extend through the resin layer and expose the second electrode sheet;
stacking, in a specific direction, a plurality of electrode sheets including the one or more first electrode sheets and the second electrode sheet such that the through hole of the one or more first electrode sheets and the exposed hole of the second electrode sheet are aligned in the specific direction to form a series of holes;
forming, by welding the resin layer of the one or more first electrode sheets and the resin layer of the second electrode sheet, an outer frame that covers peripheries of the electrode sheets, the outer frame being formed such that a first hole extends from a surface of the outer frame in the specific direction through the one or more first electrode sheets to the second electrode sheet; and
covering a side surface of the first hole with resin, the side surface of the first hole being a side surface extending in the specific direction.
